(19) United States
(12) Patent Application Publication
(10) Pub. No.: US 2006/0192981 A1
(43) Pub. Date: Aug. 31, 2006

(54) De-bursting print media output

(76) Inventors: Ismael Chanclon Fernandez, Barcelona (ES); Martin Urrutia, Barcelona (ES); Miguel Angel Ferrer, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/065,949

(22) Filed: Feb. 25, 2005

(51) Int. Cl. G06F 3/12

(52) U.S. Cl. 358/1.1

(57) ABSTRACT

A media buffer is configured, in one embodiment, to receive a burst of sheets of printed media into a buffer path sized to accommodate the burst. One or more secondary sheets contained within the burst are stalled within the buffer path, thereby increasing spacing between the sheets. The burst is then advanced downstream according to the increased spacing, such that sheets comprising the burst move downstream evenly spaced among themselves and among sheets of other bursts.

### TECHNICAL FIELD

The present disclosure relates generally to media buffers configured to receive printed media, and more particularly to a media buffer that controls spacing between sheets within the buffer.

### BACKGROUND

Some high-speed printers using inkjet or other technologies produce print output in “bursts.” Such bursts may include two, three, four or more sheets printed in very rapid succession, followed by an interval which is somewhat longer than the interval between sheets within the burst. Second and subsequent bursts may then follow. For example, three pages may be printed in a burst of very fast succession, followed by a short break and repetition of the burst.

A problem is encountered when an attempt is made to introduce the burst of printed sheet media to a finishing device, such as an accumulator. An accumulator may include stacking, hole-punching, stapling and other functionality. Unfortunately, due to the speed with which the sheets within the bursts are printed, in many cases the burst cannot be fed directly to the finishing device. As a result, where secondary processing by a finisher is desired—such as precision stacking, hole-punching and/or stapling—the finishing device may have to use a stack of printed material, rather than receive input directly from the printer. This results in an additional step—i.e. the stacking of the output from the printer—and may required that the finishing step be started only after completion of the printing process.

### SUMMARY

A media buffer is configured, in one embodiment, to receive a burst of sheets of printed media into a buffer path sized to accommodate the burst. One or more secondary sheets contained within the burst are stalled within the buffer path, thereby increasing spacing between the sheets. The burst is then advanced downstream according to the increased spacing, such that sheets comprising the burst move downstream evenly spaced among themselves and among sheets of other bursts.

### BRIEF DESCRIPTION OF THE DRAWINGS

The following description refers to the accompanying figures. In the figures, the left-most digit(s) of a reference number identifies the figure (FIG. in which the reference number first appears. Moreover, the same reference numbers are used throughout the drawings to reference like features and components.

FIG. 1 is a block diagram illustrating an example of an apparatus for de-bursting print media output.

FIG. 2 is a diagram illustrating an example of the buffer path and downstream device of the apparatus of FIG. 1.

FIG. 3 is a timing diagram illustrating an example of how the apparatus of FIG. 1 may be configured and operated.

FIG. 4 is a flow diagram that describes an example of a method to de-burst print media output.

### DETAILED DESCRIPTION

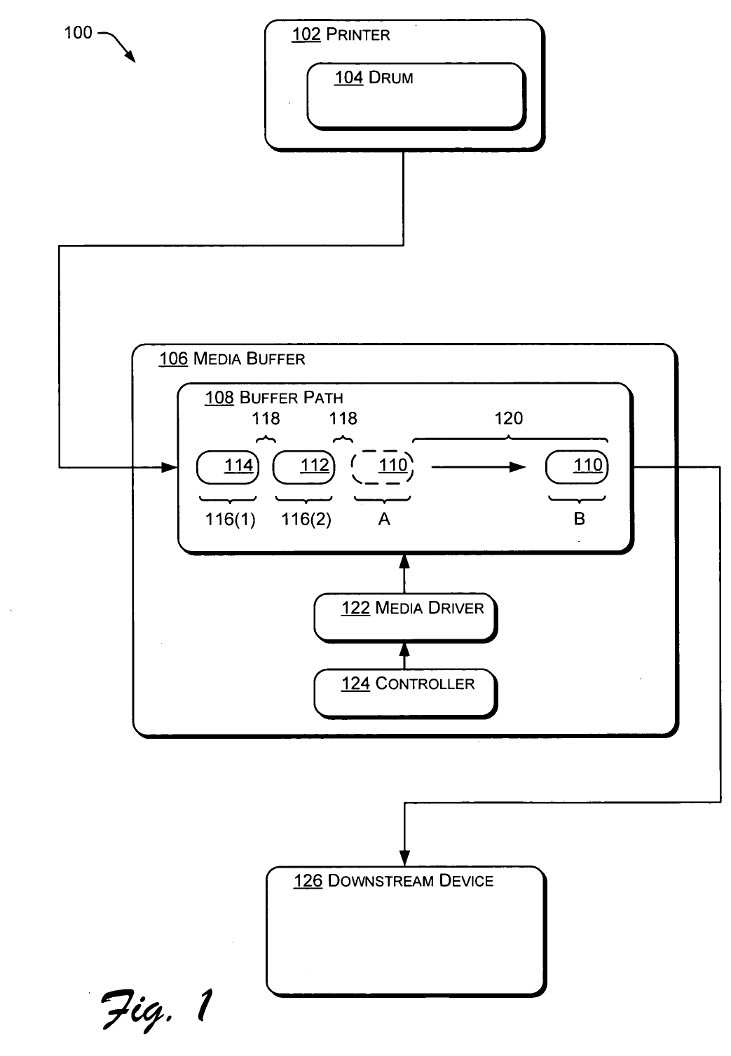

FIG. 1 is a block diagram illustrating an example of an apparatus 100 for de-bursting print media output. A printer 102 is configured, typically with a drum 104, to produce printed sheets media of media in cyclical bursts. For example, where the drum 104 is configured to hold three sheets of print media, each burst will include three sheets of media which are printed interspersed by two very short periods. A somewhat longer period of time will separate each three-page burst. Note that, while two-, three- and four-sheet bursts are common, bursts of almost any reasonable length are possible.

A media buffer 106 is configured to receive output from the printer 102. In particular, a buffer path 108 is configured to receive an entire burst of printed media. In the example of FIG. 1, a three-sheet burst includes a first sheet 110, and two secondary sheets 112 and 114. The burst of sheets 110-114 is accommodated by a number of stall locations 116 within the buffer path 108. Sheets within the three-sheet burst are initially separated by a relatively short distance 118. Upon leaving the buffer path 108, the distance between the sheets 110-114 will have increased by the distance 120.

A media driver 122 may include paired rollers or other driving mechanism, which propel the burst of sheets through the buffer path 108. Operation of the media driver 122 is orchestrated by a controller 124, which may include a microcontroller, microprocessor, application specific integrated circuit (ASIC) or other device. The controller 124 may be configured to execute software, firmware or other logic, as desired.

A downstream device 126 may include a finishing device, such as an accumulator. The accumulator may be configured to include precision sheet media stacking capabilities, hole-punching capabilities and/or media stapling capabilities. It is typically the case that the downstream device 126, such as an accumulator, cannot accept media at the burst rate (which may be 200 pages per minute (ppm) in some implementations). However, the downstream device 126 is configured to accept media at a reduced rate (such as, for example, 70 ppm), which is associated with the rate at which pages are printed when averaged over a number of bursts. Accordingly, the media buffer 106 must be configured to increase the space (and therefore the time) between sheets within the same burst exiting from the buffer path 108. In general, this is done by reducing the time between the last sheet of a first burst and the first sheet of a second burst. Having done this, sheets originally part of one or more bursts will exit from the media buffer 106 with even spacing (i.e. the same spacing between all adjacent sheets, from the same or adjacent bursts) at a rate which is compatible with input characteristics of the downstream device.

In one example of the operation of the buffer path 108, a three sheet burst, including a first or initial sheet 110 and two secondary sheets 112, 114, enters the buffer path upon discharge from the printer 102. The first sheet moves through the buffer path 108 without stalling; the secondary sheets each stall for progressively longer periods, to increase the time between each secondary sheet and the sheet preceding it. The secondary sheets stall by stopping (or slowing down) in stall locations 116. Typically, first sheet 110 continues to move through the buffer path 108 and into the downstream device without stalling. However, where the buffer path 108 contains more than one burst, the first sheet may also stall. As the first sheet 110 moves from location “A” to a location “B” the first and second secondary sheets 112, 114 are motionless (or slowed down) in stall locations 116. Accordingly, the first sheet 110 increases the distance by which it is separated from the first secondary sheet 112 by the distance 120. After the first sheet 110 increases the distance of separation by the distance 120, sheet 112 resumes movement at normal speed. After sheet 112 has moved a distance of 120, sheet 114 resumes movement at normal speed. A variation on this method of operation is to simultaneously resume movement of both sheets 112 and 114 after sheet 110 has moved by distance 120 while sheets 112 and 114 were both stalled. In this variation, sheet 114 would be advanced from location 116(1) to location 116(2), at which location it would again stall. Upon sheet 114's arrival at location 116(2), sheet 112 would pass through location “A”. As sheet 112 passed through location “B”, sheet 114 would resume movement to the downstream device 126.

In a more general view of the method of operation, each secondary sheet waits (stalls) a sufficient period of time to allow the sheet in front of it to increase its lead by a distance (e.g. distance 120) before un-stalling (i.e. resuming normal speed). It therefore follows that secondary sheets leaving the buffer path later will be stalled progressively longer than secondary sheets leaving the buffer path earlier. Thus, each sheet is separated by a combination of distances 118 and 120 from leading and following sheets. Similarly, (in one embodiment) the first sheet of a subsequent burst is timed to enter the buffer path 108 the combined distance behind the last secondary sheet of the preceding burst. In an alternative embodiment wherein the buffer path can accommodate more than one burst, the first sheet of the next burst is timed to resume movement so that the distance between it and the last sheet of the prior burst are spaced uniformly.

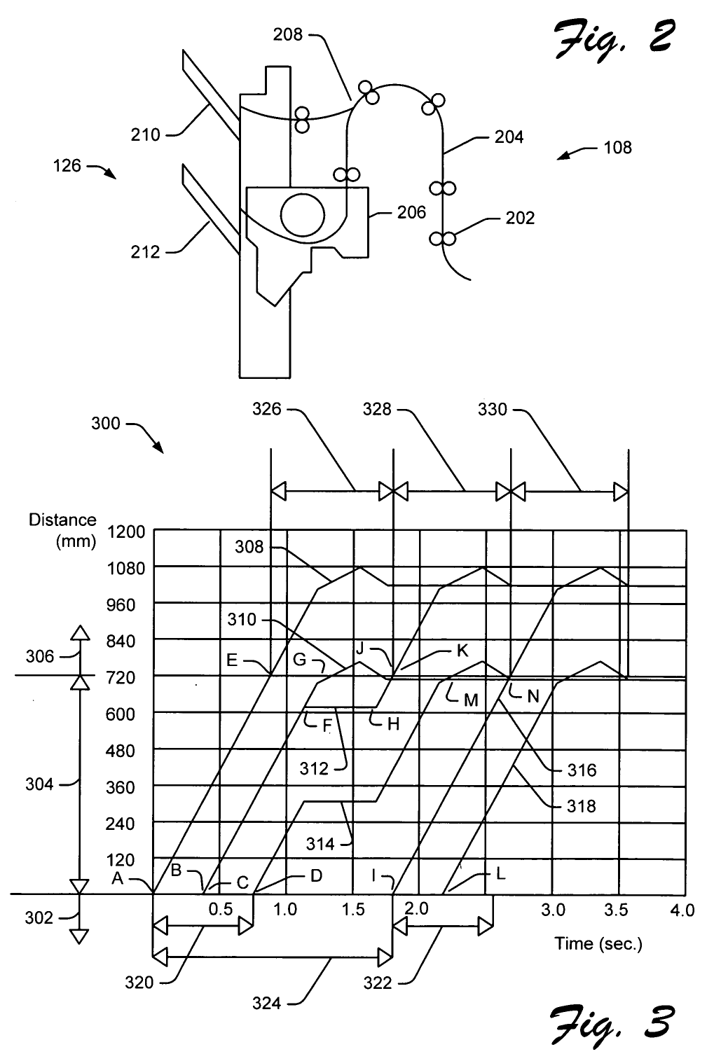

FIG. 2 is a diagram illustrating an example of the buffer path 108 and downstream device 126 of the apparatus 100 of FIG. 1. The buffer path 108 includes a media driver, such as roller pairs 202 which guide print media sheets on a track 204. The downstream device 126 may include a finisher such as an accumulator 206. The accumulator may be configured for precision media stacking, hole-punching, media stapling or other functionality. The track 204 may include a “Y,” 208 wherein a first fork of the Y 208 is configured to deliver media to a first paper tray 210, and a second fork of the Y 208 is configured to deliver media to the accumulator 206. Media processed by the accumulator 206 is delivered to the second paper tray 212.

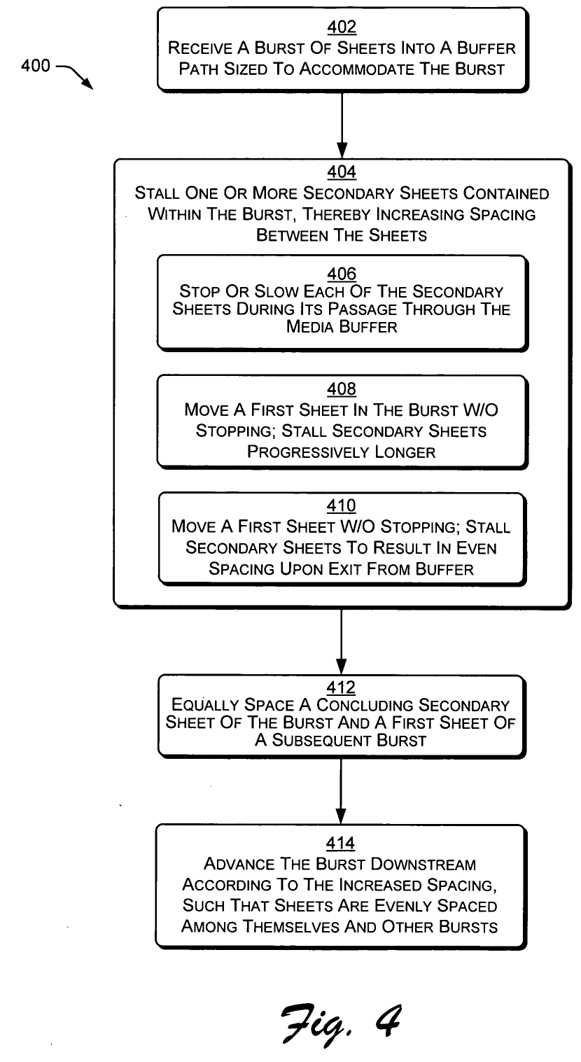

FIG. 3 is a timing diagram 300 illustrating further exemplary detail on the operation of the apparatus 100 of FIG. 1. In the diagram 300, the horizontal axis shows time (in seconds) and the vertical axis shows distance (in mm) by which the sheets of print media move through three regions. In particular, a first region 302 is inside the printer, and is generally below the graph. A second region 304 shows sheet media movement through the buffer path 108 (FIGS. 1 and 2). A third region 306 shows sheet media movement through the downstream device 126 (FIGS. 1 and 2), such as an accumulator.

The timing diagram 300 shows both sheets of a two-sheet burst, as well as the first sheet of a second burst. Accordingly, the diagram 300 shows the location (in mm) of the leading and trailing edges of three sheets of paper. In particular, the diagram 300 shows the position as a function of time of the leading and trailing edges 308, 310 of the first sheet of the first burst. Similarly, the leading and trailing edges 312, 314 of the second sheet of the first burst are seen. Note that since the leading edge 312 of the second sheet follows very quickly after the trailing edge 310 of the first sheet, these lines merge in part of the diagram. Also shown are the leading and trailing edges 316, 318 of the first sheet of a second burst.

The reader will note that the leading and trailing edges 312, 314 of the second sheet of the first burst stop moving from approximately 1.1 seconds until 1.7 seconds. During this time, the first sheet of the first burst extends its lead over the second sheet of the first burst. This positions the second sheet of the first burst precisely between the first sheet of the first burst and the first sheet of the second burst.

The first burst enters the region 304 associated with the buffer path within a narrow period of time 320. The second burst enters the buffer path region 304 during the time period 322. The time period 324 is associated with the total cycle, i.e. the period from the start of one burst until the start of a second burst.

The time periods 326-330 show how the three sheets become equally spaced upon their arrival in the accumulator region 306.

Other aspects of the timing diagram 300 may be understood in view of a discussion of certain key areas within the diagram. At location “A” on the diagram, the leading edge of the first page of the burst comes from the printer 102 into the buffer path 108 (FIG. 1) (i.e. the buffer region 304 of timing diagram 300). At location “B”, the trailing edge of the first page of the burst comes into the buffer path. The first page is then fully located within the buffer path. At location “C”, after a small gap of time (e.g. 10 ms, but dependent on the system) the leading edge of the second page of the burst comes into the buffer path. Note that the trailing edge of the first sheet and the leading edge of the second sheet are essentially graphed by the same line between “C” and “F”. At location “D” the trailing edge of the second page of the burst comes into the buffer path, thereby fully loading the second page into the buffer path. Together, the first and second pages comprises a burst, and may be loaded very rapidly, such as at a rate of 200 pages per minute. At location “E”, the leading edge of the first page leaves the graphed region 304 associated with the buffer path and enters the graphed region 306 associated with a downstream device 126, such as an accumulator. The accumulation cycle starts for this sheet. Location “F” is representative of locations wherein the second page may be stopped or stalled, or its speed reduced. The stalling increases the gap between the first and second pages. Note that in timing diagram 300 the burst includes two sheets: the first sheet and only one secondary sheet. In FIG. 1, two secondary sheets 112 and 114 are shown, both of which are positioned in locations (e.g. 116(1) and 116(2)) to stall. At location “G”, the trailing edge of the first page leaves the buffer paper path. The accumulator starts to work stacking (or otherwise processing) the first page of the print job. At location “H”, after a delay from location “F”, the second page is accelerated (i.e. the “stall” of the second page is ended) and the second page is conducted into the accumulator. The delay represents the time spent stalling the second page, and is seen by a comparison of locations “F” and “H”. Referring back to FIG. 1, the delay is associated with the time spent by the first page moving the distance 120. At location “I”, the buffer path is now empty enough to allow a new burst to begin to enter the buffer path. Note that this implementation allows the second burst cycle to enter the buffer path before the first burst cycle has fully exited the buffer path. Either implementation is workable, and could be implemented depending on other design goals. Accordingly, at “I”, the leading edge of the first page of the second burst comes into the buffer path from the printer. At “J”, the accumulator has finished stacking the first page. The accumulator is therefore available to accept the second page of the first burst for stacking. Accordingly, the accumulator or other downstream device 126 is operated at a constant speed, notwithstanding the fact that the printer produces pages in a series of bursts. At “K”, the leading edge of the second page comes into the accumulator. Accordingly, the accumulation cycle starts again, to process the second page of the first burst. At “L”, the trailing edge of the first page of the second burst cycle comes into the buffer path. Accordingly, the first page is fully loaded into the buffer path. The handling of the second burst may be understood by reviewing conditions from “C” onward. At “M”, the trailing of the second page of the first burst leaves the buffer path. The downstream device 126 then begins to process this page; for example, where the downstream device is an accumulator, the page is stacked. At “N” the accumulator has finished stacking the first burst, and is available to begin stacking the second burst.

FIG. 4 is a flow diagram that describes a first example of a method 400 to de-burst print media output. At block 402, a burst of sheets is received into a buffer path sized to accommodate the burst. Each burst includes a first page and one or more secondary sheets. In the example seen in FIG. 1, a three-sheet burst including sheets 110-114 enter the buffer path 108. This burst includes a first page, which passes through the buffer without stalling, and two secondary sheets which are stalled for progressively longer periods.

At block 404, the one or more secondary sheets contained within the burst are stalled. In some applications, such as that seen in FIG. 1, the first sheet is not stalled. However, by stalling the one or more secondary sheets within the burst, the spacing between sheets of printed media within the burst is increased. By properly timing the stall periods, the spacing between all sheets is equalized. Several examples seen at blocks 406-412 illustrate aspects and options associated with the stalling of the secondary sheets.

In an example first aspect, at block 406, the first sheet is moved through the buffer path 108 (FIG. 1) without stalling. However, each secondary sheet is stalled to result in even spacing upon exit from the buffer path. Stalling can be performed by slowing or stopping the sheet. For example, as seen in FIG. 3, even spacing between all sheets upon exit from the buffer path is achieved by stalling the second sheet. The stalling is seen in the timing diagram 300 by noting how the leading and trailing edges of sheet 2 do not advance during the stall (from “F” to “H”), which takes place from t=1.1 seconds until t=1.7 seconds. However, as a result of the stall, the sheets are evenly spaced upon exit from the buffer path 108 (FIG. 1). The even spacing can be seen in timing diagram 300 of FIG. 3 by the even spacing of times 326-330, during which the three sheets move within the accumulator region 306 (FIG. 3).

In an example of a second aspect, at block 408 the first sheet is moved through the buffer path 108 (FIG. 1) without stopping. However, each secondary sheet is moved through the buffer more slowly than the first sheet; in particular, each secondary sheet to pass through the buffer is stalled for a progressively longer period, i.e. upstream secondary sheets are stalled for longer periods than downstream secondary sheets. Returning to FIG. 1 as an example, the first sheet 110 in the burst is not stalled. However, secondary sheet 112 is stalled while the first sheet moves from “A” to “B,” i.e. while the first sheet is advanced by distance 120. Secondary sheet 114 is stalled for that time also, but is additionally stalled while sheet 112 is also advanced for by distance 120. Thus, each sheet within the secondary sheets is stalled for a longer period than the sheet downstream from it. Note that in one implementation, a secondary sheet may stall in one location only; however, in alternative implementations, the time spent stalling by any secondary sheet may be divided between time spent waiting (stalling) in two or more locations. Referring to FIG. 1 for purposes of illustration, secondary sheet 114 may stall in location 116(1) while sheet 110 moves from “A” to B”. Secondary sheet 114 may then move into location 116(2), wherein it stalls as sheet 112 moves from “A” to “B”.

In an example of a third aspect, at block 410 the first sheet is moved through the buffer path 108 (FIG. 1) without stopping. However, each secondary sheet is stalled for a time period calculated to result in even spacing upon exit from the buffer. Referring to FIG. 1, by adding the distance 120 to the spacing between each of the sheets within each burst, even spacing between all sheets in all bursts is achieved.

Note that while sheet one in each burst is typically not stalled, there is no reason why this sheet could not also be stalled. However, the buffer path may have to be elongated, and the secondary sheets stalled for longer periods of time.

At block 412, a final secondary sheet in the burst (or the only secondary sheet in a two-page burst) is equally spaced between a preceding page and a first sheet of a subsequent burst. The preceding page may be the first page of the burst (if the burst is two-page) or the penultimate secondary page of the burst (if there are at least two secondary pages in the burst). FIG. 3 illustrates this point, wherein the (sole) secondary sheet in the first burst is equally spaced between the first sheets of the first and second bursts upon the first sheet of the second burst leaving the buffer path. The equal spacing can be seen by examination of the equal distances 326, 328 and 330. Note that while equally-spaced sheets (e.g. pages) are typically desirable, non-equally-spaced sheets could alternatively be generated by the media buffer 106. For example, the controller 124 could be configured to adjust the stall period of one or more secondary sheets in each burst to result in different spacing between sheets.

At block 414, the burst is advanced downstream according to the increased spacing, such that sheets are even spaced among themselves and other bursts. As a result, the sheets are advanced into the downstream device at a rate less than or equal to a maximum rate at which the downstream device can accept sheets by increasing spacing between the first sheet and the one or more secondary sheets.

Although the above disclosure has been described in language specific to structural features and/or methodological steps, it is to be understood that the appended claims are not limited to the specific features or steps described. Rather, the specific features and steps are exemplary forms by which this disclosure may be implemented. For example, while actions described in blocks of the flow diagrams may be performed in parallel with actions described in other blocks, the actions may occur in an alternate order, or may be distributed in a manner which associates actions with more than one other block. And further, while elements of the methods disclosed are intended to be performed in any desired manner, it is anticipated that computer- or processor-readable instructions, performed by a computer and/or processor, reading from a computer- or processor-readable media, such as a ROM, disk or CD ROM, would be preferred, but that a gate array or an application specific integrated circuit (ASIC) or similar hardware structure, could be substituted.

1. A method of de-bursting print media output, comprising:
receiving a burst of sheets of printed media into a buffer path sized to accommodate the burst;
stalling one or more secondary sheets contained within the burst, thereby increasing spacing between the sheets; and
advancing the burst downstream according to the increased spacing, such that sheets comprising the burst move downstream evenly spaced among themselves and among sheets of other bursts.

2. The method of claim 1, wherein stalling one or more secondary sheets comprises:
locating the burst of sheets in the buffer path, wherein a first sheet moves without stopping through the buffer path and each of the one or more secondary sheets stalls for progressively longer periods of time before leaving the buffer path, thereby evenly spacing the sheets with sheets from other bursts upon leaving the buffer path.

3. The method of claim 1, wherein stalling one or more secondary sheets comprises:
locating the burst of sheets in the buffer path, wherein a first sheet moves without stopping through the buffer path and each of the one or more secondary sheets stall for periods of time calculated to evenly space the sheets with sheets from other bursts upon leaving the buffer path.

4. A media buffer, comprising:
a buffer path;
a media driver, configured to move media traveling within the buffer path; and
a controller, configured to operate the media driver for:
receiving a burst of printed media into the buffer path;
stalling one or more secondary sheets contained within the burst; and
advancing sheets comprising the burst of printed media downstream, such that the sheets move downstream in an evenly spaced manner.

5. The media buffer of claim 4, wherein the media driver comprises:
paired sheet feed rollers.

6. The media buffer of claim 5, wherein the buffer path comprises:
a number of stall locations, wherein the number is proportional to length of the burst.

7. The media buffer of claim 4, wherein the buffer path comprises a “Y”,
wherein a first fork of the Y is configured to deliver media to a paper tray and the second fork of the Y is configured to deliver media to a downstream device.

8. The media buffer of claim 4, wherein stalling the one or more secondary sheets comprises:
moving each of the one or more secondary sheets through the media buffer more slowly than a first sheet of the burst of printed media was moved through the media buffer.

9. The media buffer of claim 4, wherein stalling the one or more secondary sheets comprises:
stopping each of the one or more secondary sheets during its passage through the media buffer.

10. The media buffer of claim 4, wherein stalling the one or more secondary sheets comprises:
equally spacing a concluding secondary sheet of the burst between a penultimate sheet of the one or more secondary sheets and a first sheet of a subsequent burst.

11. The media buffer of claim 4, wherein advancing sheets comprising the burst of printed media downstream comprises:
advancing sheets into a downstream device at a rate less than or equal to a maximum rate at which the downstream device can accept sheets by increasing spacing between the first sheet and the one or more secondary sheets.

12. The media buffer of claim 4, wherein the controller is additionally configured for:
advancing a first sheet from a second burst through the buffer path and into a downstream device, such that the first sheet from the second burst is evenly spaced with preceding sheets.

13. The media buffer of claim 4, wherein the controller is additionally configured for:
advancing sheets within a second burst to follow, upon leaving the buffer path, sheets within the first burst at a distance which spaces all sheets within the first and second bursts equally.

14. A print system, comprising:
a printer, configured to generate a burst of printed sheets;
a media buffer, configured to receive the burst of printed sheets generated by the printer and to deliver sheets separated by an even distance; and
a finisher, configured to receive the sheets separated by the even distance.

15. The print system of claim 14, wherein the printer comprises a drum, configured to produce the burst of printed sheets.

16. The print system of claim 14, wherein the media buffer comprises:
a buffer path, having a length of at least a distance sufficient to contain the burst of printed sheets;
a controller to stall all but an initial sheet of the burst of printed sheets; and
a plurality of rollers, operating in response to the controller, to drive the burst.

17. The print system of claim 16, wherein the controller is configured to execute instructions for:
upon passing the initial sheet of the burst of printed sheets without stalling, stalling each secondary sheet within the burst of printed sheets for an increasingly long period of time.

18. The print system of claim 14, wherein the media buffer comprises:
a buffer path, having a length sufficient to contain the burst of printed sheets; and
a number of stall locations within the buffer path proportional to length of the burst.

19. The print system of claim 14, wherein the media buffer comprises a controller, configured to operate the media buffer by:
stalling one or more secondary sheets contained within the burst of printed sheets; and
advancing sheets comprising the burst of printed sheets into a downstream device, such that sheets entering the downstream device do so evenly spaced.

20. A processor-readable medium comprising processor-executable instructions for de-bursting output of a printer to result in sheets separated by an even distance, the processor-executable instructions comprising instructions for:
moving a first sheet in a burst of sheets into a paper path;
moving one or more secondary sheets contained within the burst of sheets into the paper path; and
stalling each of the one or more secondary sheets while they are in the paper path for a period timed to equalize distance between all adjacent sheets leaving the paper path, including those of prior and subsequent bursts.

21. The processor-readable medium of claim 20, wherein stalling each of the one or more the secondary sheets comprises:
stalling each of the one or more secondary sheets for progressively longer periods of time before leaving the buffer path.

22. The processor-readable medium of claim 20, wherein stalling each of the one or more secondary sheets comprises:
slowing or stopping each of the one or more secondary sheets relative to the first sheet for one or more periods of time, respectively, each period of time long enough to equalize distance between all sheets leaving the paper path.

23. The processor-readable medium of claim 20, wherein stalling each of the one or more secondary sheets comprises:
moving the one or more secondary sheets at different speeds at different times within the buffer path.

24. The processor-readable medium of claim 20, additionally comprising:
concluding a final secondary sheet's stall by resuming movement of the final secondary sheet at a time which maintains the final secondary sheet at the equalized distance ahead of a first sheet contained in a second burst.

25. A processor-readable medium comprising processor-executable instructions for managing output of a printer, the processor-executable instructions comprising instructions for:
loading a burst of sheets into a paper path;
moving a first sheet of the burst through the paper path without stalling;
locating one or more secondary sheets within the burst into one or more stall locations, respectively;
stalling the one or more secondary sheets; and
restarting each of the one or more secondary sheets within the one or more stall locations according to an order of their arrival within the paper path.

26. The processor-readable medium of claim 25, wherein stalling the one or more secondary sheets comprises:
slowing or stopping the one or more secondary sheets.

27. The processor-readable medium of claim 25, wherein restarting each of the one or more secondary sheets comprises:
separating each sheet within the burst of sheets by an even distance.

28. The processor-readable medium of claim 25, additionally comprising:
timing transmission of a second burst of sheets into the paper path such that a first sheet of the second burst is separated by a distance equal to a distance by which each of the burst of sheets are separated upon leaving the paper path.

29. A media buffer for de-bursting output of a printer to result in sheets separated by an even distance, wherein the media buffer comprises:
means for moving a first sheet in a burst of sheets into a paper path;
means for moving one or more secondary sheets contained within the burst of sheets into the paper path; and
means for stalling each of the one or more secondary sheets while they are in the paper path for a period timed to equalize distance between all adjacent sheets leaving the paper path, including those of prior and subsequent bursts.

30. The media buffer claim 29, wherein the means for stalling each of the one or more the secondary sheets comprises:
means for stalling each of the one or more secondary sheets for progressively longer periods of time before leaving the buffer path.

31. The media buffer of claim 29, wherein the means for stalling each of the one or more secondary sheets comprises:
means for slowing or stopping each of the one or more secondary sheets relative to the first sheet for one or more periods of time, respectively, each period of time long enough to equalize distance between all sheets leaving the paper path.

32. The media buffer of claim 29, additionally comprising:
means for moving the one or more secondary sheets at different speeds at different times within the buffer path.

33. The media buffer of claim 29, additionally comprising:
means for concluding a final secondary sheet's stall by resuming movement of the final secondary sheet at a time which maintains the final secondary sheet at the equalized distance ahead of a first sheet contained in a second burst.
